(19) United States
(12) Patent Application Publication
(10) Pub. No.: US 2016/0305843 A1
(43) Pub. Date: Oct. 20, 2016

(54) ROTATING BODY BALANCE CORRECTING APPARATUS AND ROTATING BODY BALANCE CORRECTING METHOD

(71) Applicant: TOYOTA JIDOSHA KABUSHIKI KAISHA, Toyota-shi (JP)

(72) Inventors: Koji NOMURA, Toyota-shi (JP); Osamu MAEDA, Toyota-shi (JP); Akihiro ASANO, Toyota-shi (JP)

(73) Assignee: TOYOTA JIDOSHA KABUSHIKI KAISHA, Toyota-shi (JP)

(21) Appl. No.: 15/091,187

(22) Filed: Apr. 5, 2016

(30) Foreign Application Priority Data
Apr. 14, 2015 (JP) 2015-082630

(51) Int. Cl. G01M 1/30

(52) U.S. Cl. CPC G01M 1/30

(57) ABSTRACT

A balance of a rotating body is measured by a balance measuring device while the rotating body is rotated. The balance of the rotating body is corrected by irradiating a laser with a laser radiation device at a first processing portion of the rotating body that is set based on the measurement result and removing that processing portion. After the first processing portion of the rotating body is removed, the balance of the rotating body is measured again. If the measurement result is a result in which the balance correction is insufficient, the rotating body is rotated at a speed lower than a rotation speed of the rotating body when the first processing portion is removed, and the laser is irradiated by the laser irradiating portion at a second processing portion of the rotating body set based on the result of measuring the balance again, and the second processing portion is removed.

### INCORPORATION BY REFERENCE

The disclosure of Japanese Patent Application No. 2015-082630 filed on Apr. 14, 2015 including the specification, drawings and abstract is incorporated herein by reference in its entirety.

### BACKGROUND OF THE INVENTION

1. Field of the Invention

The invention relates to a rotating body balance correcting apparatus and rotating body balance correcting method that corrects the balance of a rotating body.

2. Description of Related Art

Japanese Patent Application Publication No. 2011-112514 (JP 2011-112514 A) describes one balance correcting apparatus. With the apparatus described in JP 2011-112514 A, first the balance of the rotating body is measured. More specifically, an imbalance phase that is a portion that needs to be removed (i.e., a rotation phase about the rotation center) of a rotating body for correcting the balance of the rotating body, and an imbalance amount that is an amount that needs to be removed from the rotating body in order to correct the balance, are measured by a well-known measuring device having an acceleration sensor. Then, while the rotating body is rotating, a laser is irradiated at a processing portion of the rotating body that is determined based on the measurement results from the balance measuring device. As a result, the processing portion of the rotating body melts and flies off, and is thus removed, such that the balance of the rotating body is corrected.

In the apparatus described in JP 2011-112514 A, in order to efficiently correct the balance of the rotating body, it is conceivable to perform the work of irradiating the laser while rotating the rotating body at high speed. As a result, the process of removing the processing portion of the rotating body is able to be finished in a short period of time, so correction of the balance of the rotating body is able to be completed in a short period of time.

However, when the rotating body is rotated at high speed, vibration of the rotating body tends to become large, so there tends to be errors in the portion where some of the rotating body is to be removed as well as in the amount that is removed, due to misalignment of the area where the laser is irradiated, and consequently, the balance correction accuracy ends up decreasing. Therefore, the balance of the rotating body is unable to be appropriately corrected, and measurement of the balance and follow-up correction of the balance based on the measurement results will need to be repeated, and as a result, it may take a long time to correct the balance of the rotating body.

### SUMMARY OF THE INVENTION

In view of this, the invention thus provides a rotating body balance correcting apparatus and a rotating body balance correcting method capable of efficiently correcting the balance of a rotating body is a short period of time.

Therefore, a first aspect of the invention relates to a rotating body balance correcting apparatus that includes a measuring device, a laser radiation device, and a controller. The measuring device is configured to measure a balance of a rotating body. The laser radiation device is configured to irradiate a laser at a surface of the rotating body. The controller configured to: (i) control operation of the measuring device and the laser radiation device, (ii) correct the balance of the rotating body by irradiating the laser with the laser radiation device at a first processing portion of the rotating body set based on a result of measuring the balance by the measuring device while the rotating body is rotated, and removing the first processing portion, (iii) measure the balance of the rotating body again after the first processing portion has been removed, and (iv) rotate the rotating body at a speed different from a rotation speed of the rotating body when the first processing portion is removed, and irradiate the laser with the laser radiation device at a second processing portion of the rotating body set based on a result of measuring the balance again, and remove the second processing portion, when the result of measuring the balance again is a result in which the correction of the balance is insufficient.

Here, in the balance correcting apparatus described above, the controller may be configured to make a rotation speed of the rotating body when the laser is irradiated at the second processing portion lower than a rotation speed of the rotating body when the laser is irradiated at the first processing portion. Also, the controller may be configured to make a rotation phase area where the laser is irradiated at the second processing portion different from a rotation phase area where the laser is irradiated at the first processing portion by 180°.

According to the balance correcting apparatus as described above, vibration of the rotating body, and thus misalignment of the area where the laser is irradiated, are able to be inhibited by reducing the rotation speed of the rotating body, so the balance correction accuracy of the rotating body increases.

Also, according to the balance correcting apparatus as described above, if, as a result of removing the first processing portion of the rotating body while the rotating body is rotated, the balance correction of the rotating body is insufficient, the second processing portion of the rotating body may be removed while the rotating body is rotated at a lower speed than when the first processing portion is removed, i.e., while the rotating body is rotated at a speed at which high correction accuracy can be expected. As a result, it possible to inhibit the balance measurement by the measuring device and another (i.e., a follow-up) balance correction based on those measurement results from being repeated, so the balance correction of the rotating body is able to be efficiently performed in a short period of time.

Also, in the balance correcting apparatus described above, the laser radiation device may be configured to irradiate the laser at an end portion of the rotating body in an extending direction of a rotation center of the rotating body, and remove an arc-shaped portion around the rotation center from the end portion. The controller may be configured to position the second processing portion closer to an inner peripheral side near the rotation center than the first processing portion.

According to the balance correcting apparatus as described above, when an arc-shaped portion around the rotation center is removed from the tip end portion of the rotating body in the extending direction of the rotation center of the rotating body, the length around the rotation center of the portion where the processing portion that is the portion that is removed can be set becomes longer, and thus the area where the processing portion can be set becomes wider, the farther the processing portion is to the outer peripheral side away from the rotation center.

Also, if a hole formed in the rotating body with the removal by the laser emission becomes too deep, the material melted by the laser emission may be unable to be excreted outside of the hole and fly off. Also, if the first processing portion in the first balance correction and the second processing portion in the follow-up balance correction are set to the same region, the region that was processed once in the first balance correction will be processed again in the follow-up balance correction, so the hole formed in the rotating body tends to become deep. As a result, the removal amount that can be removed from the rotating body by the laser emission may be less.

According to the balance correcting apparatus as described above, when the first balance correction is performed, the first processing portion is able to be set to a portion on the outer peripheral side, i.e., a portion in which the area where the first processing portion can be set is large, of the tip end portion of the rotating body, so the first processing portion can be set with a high degree of freedom. Also, if there is a need for another balance correction, the second processing portion is set to a region closer to the inner peripheral side of the tip end portion of the rotating body than the first processing portion in the first balance correction, i.e., to a region that differs from the first processing portion. Therefore, the removal amount that can be removed in both the first balance correction and the follow-up balance correction is able to be increased. In this way, according to the balance correcting apparatus described above, the balance correction of the rotating body is able to be performed with a high degree of freedom.

Also, in the balance correcting apparatus described above, the second processing portion may include a plurality of processing portions lined up from a position on an outer peripheral side away from the rotation center toward a position on an inner peripheral side near the rotation center, and the controller may be configured to: (i) irradiate a laser in which an irradiated energy per unit time is constant, at the plurality of processing portions, and (ii) increase a rotation speed of the rotating body when a target at which the laser is irradiated is a processing portion that is closer to the inner peripheral side, from among the plurality of processing portions.

When a laser with a constant emission energy per unit of time is irradiated for a certain period of time at the rotating body while the rotating body is rotated at a predetermined speed, the length in the circumferential direction of the portion where the laser is irradiated becomes shorter the closer the irradiated portion is to the inner peripheral side near the rotation center of the rotating body, so the amount of energy per unit area that is applied to the rotating body by irradiating the laser is greater the closer the irradiated portion is to the inner peripheral side near the rotation center of the rotating body. Therefore, if the rotation speed of the rotating body is constant when the laser is irradiated separately at the plurality of processing portions that are lined up from a position on the outer peripheral side away from the rotation center of the rotating body toward a position on the inner peripheral side near the rotation center of the rotating body, there will be variation in the amount of energy per unit area that is applied to the rotating body between these processing portions, so there may be variation in the removal of the processing portions.

According to the balance correcting apparatus as described above, when removing the second processing portion, the rotation speed of the rotating body is a higher speed when the target of laser emission is a processing portion that is closer to the inner peripheral side, from among the plurality of processing portions. Therefore, variation in the length in the circumferential direction of the irradiated portion when a laser in which the irradiated energy per unit time is a constant energy is irradiated for a certain period of time is able to be reduced between the plurality of processing portions, so variation in the amount of energy per unit area that is applied to the rotating body by emission of the laser is able to be reduced between the plurality of processing portions. As a result, the setting for the removal of each processing portion of the second processing portion is able to be performed easily, so the balance is able to be easily corrected.

Another aspect of the invention relates to a balance correcting method of a rotating body that includes a first measuring process, a first setting process, a first correcting process, a second measuring process, a second setting process, and a second correcting process. The first measuring process measures a balance of a rotating body. The first setting process sets a first processing portion of the rotating body based on a result of measuring the balance in the first measuring process. The first correcting process corrects the balance of the rotating body by irradiating a laser at the first processing portion while the rotating body is being rotated at a first speed and removing the first processing portion. The second measuring process measures the balance of the rotating body after the first correcting process. The second setting process sets a second processing portion of the rotating body based on a result of measuring the balance in the second measuring process, when a measurement result of the balance in the second measuring process is a result indicating that the correction of the balance of the rotating body in the first correcting process is insufficient. The second correcting process corrects the balance of the rotating body again by irradiating the laser at the second processing portion when the rotating body is rotated at a second speed that differs from the first speed and removing the second processing portion.

Here, in the second correcting process, a rotation speed of the rotating body when the laser is irradiated at the second processing portion may be lower than a rotation speed of the rotating body when the laser is irradiated at the first processing portion. Also, in the second correcting process, a rotation phase area where the laser is irradiated at the second processing portion may be made to differ from a rotation phase area where the laser is irradiated at the first processing portion. Furthermore, in the second correcting process, a rotation phase area where the laser is irradiated at the second processing portion may be made to differ from a rotation phase area where the laser is irradiated at the first processing portion by 180°.

According to the balance correcting method of a rotating body as described above, vibration of the rotating body, and thus misalignment of the area where the laser is irradiated, are able to be inhibited by reducing the rotation speed of the rotating body, so the balance correction accuracy of the rotating body increases.

Also, according to the balance correcting method described above, if, as a result of removing the first processing portion of the rotating body while the rotating body is rotated at a first speed in the first correcting process, the balance correction of the rotating body is insufficient, the second processing portion of the rotating body may be removed while the rotating body is rotated at a lower speed than in the first correcting process, i.e., while the rotating body is rotated at a speed at which high correction accuracy can be expected. As a result, it possible to inhibit the balance measurement by the measuring device and another balance correction based on that measurement result from being repeated, so the balance correction of the rotating body is able to be efficiently performed in a short period of time.

Also, in the balance correcting method described above, removal of the first processing portion in the first correcting process and removal of the second processing portion in the second correcting process may be executed by irradiating the laser at an end portion of the rotating body in an extending direction of a rotation center of the rotating body, and removing an arc-shaped portion around the rotation center from the end portion. Also, in the second correcting process, the second processing portion may be positioned closer to an inner peripheral side near the rotation center than the first processing portion.

When an arc-shaped portion around the rotation center is removed from the tip end portion of the rotating body in the extending direction of the rotation center of the rotating body, the length around the rotation center of the portion where the processing portion that is the portion that is removed can be set becomes longer, and thus the area where the processing portion can be set becomes wider, the farther the processing portion is to the outer peripheral side away from the rotation center.

Also, if a hole formed in the rotating body with the removal by the laser emission becomes too deep, the material melted by the laser emission may be unable to be excreted outside of the hole and fly off. Also, if the first processing portion in the first balance correction and the second processing portion in the second balance correction are set to the same region, the region that was processed once in the first balance correction will be processed again in the second balance correction, so the hole formed in the rotating body tends to become deep. As a result, the removal amount that can be removed from the rotating body by the laser emission may be less.

According to the balance correcting method described above, in the first balance correction, the first processing portion is able to be set to a portion on the outer peripheral side, i.e., a portion in which the area where the processing portion can be set is large, of the tip end portion of the rotating body, so the processing portion can be set with a high degree of freedom. Also, if there is a need for another balance correction to be performed in the second correcting process, the second processing portion is set to a region closer to the inner peripheral side of the tip end portion of the rotating body than the first processing portion in the first balance correction, i.e., to a region that differs from the first processing portion. Therefore, the removal amount that can be removed in both the first correcting process and the second correcting process is able to be increased. In this way, according to the balance correcting method described above, the balance correction of the rotating body is able to be performed with a high degree of freedom.

Moreover, in the balance correcting method described above, in the second setting process, a plurality of processing portions that are lined up from a position on an outer peripheral side away from the rotation center toward a position on an inner peripheral side near the rotation center may be set as the second processing portion, and in the second correcting process, a laser in which an irradiated energy per unit time is constant is irradiated at the plurality of processing portions, and a rotation speed of the rotating body is increased when a target at which the laser is irradiated is a processing portion that is closer to the inner peripheral side, from among the plurality of processing portions.

When a laser with a constant emission energy per unit of time is irradiated for a certain period of time at the rotating body while the rotating body is rotated at a predetermined speed, the length in the circumferential direction of the portion where the laser is irradiated becomes shorter the closer the irradiated portion is to the inner peripheral side near the rotation center of the rotating body, so the amount of energy per unit area that is applied to the rotating body by irradiating the laser is greater the closer the irradiated portion is to the inner peripheral side near the rotation center of the rotating body. Therefore, if the rotation speed of the rotating body is constant when the laser is irradiated separately at the plurality of processing portions that are lined up from a position on the outer peripheral side away from the rotation center of the rotating body toward a position on the inner peripheral side near the rotation center of the rotating body, there will be variation in the amount of energy per unit area that is applied to the rotating body between these processing portions, so there may be variation in the removal of the processing portions.

According to the balance correcting method described above, the rotation speed of the rotating body is a higher speed when the target of laser emission in the second setting process is a processing portion that is closer to the inner peripheral side, from among the plurality of processing portions. Therefore, variation in the length in the circumferential direction of the irradiated portion when a laser in which the irradiated energy per unit time is a constant energy is irradiated for a certain period of time is able to be reduced between the plurality of processing portions, so variation in the amount of energy per unit area that is applied to the rotating body by emission of the laser is able to be reduced between the plurality of processing portions. As a result, the setting for the removal of the second processing portion in the second correcting process is able to be performed easily, so the balance is able to be easily corrected.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a sectional view of a balance correcting apparatus according to a first example embodiment of the invention;

FIG. 2 is a flowchart illustrating an execution sequence of steps in a balance correction routine according to the first example embodiment;

FIGS. 3A to 3C are timing charts illustrating one example of the manner in which the balance correction routine of the first example embodiment is executed;

FIG. 4 is a simplified diagram of a laser irradiating region on a tip end portion of a compressor impeller and a tip end portion of a turbine wheel to be processed by the balance correcting apparatus of the first example embodiment;

FIG. 5 is a simplified diagram of a laser irradiating region on a tip end portion of a compressor impeller and a tip end portion of a turbine wheel to be processed by the balance correcting apparatus of a second example embodiment of the invention;

FIG. 6 is a flowchart illustrating an execution sequence of steps in a balance correction routine according to the second example embodiment;

FIG. 7 is a simplified diagram showing the relationship between the laser irradiating region and a length in the circumferential direction of a portion where the laser is emitted;

FIG. 8 is a simplified diagram of a laser irradiating region on a tip end portion of a compressor impeller and a tip end portion of a turbine wheel to be processed by the balance correcting apparatus of a fifth modified example of the example embodiments; and

FIG. 9 is a simplified diagram of a laser irradiating region on a tip end portion of a compressor impeller and a tip end portion of a turbine wheel to be processed by the balance correcting apparatus of a seventh modified example of the example embodiments.

### DETAILED DESCRIPTION OF EMBODIMENTS

Hereinafter, a first example embodiment of the rotating body balance correcting apparatus and balance correcting method will be described.

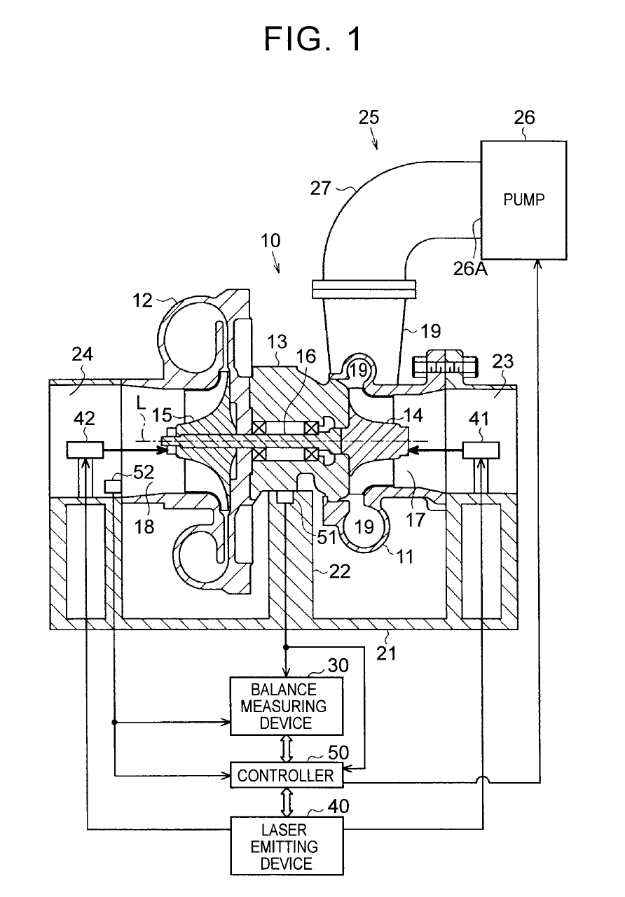

As shown in FIG. 1, a supercharger 10 is mounted to a balance correcting apparatus according to this first example embodiment. The supercharger 10 includes an exhaust turbine 11, a compressor 12, and a center housing 13 that connects the exhaust turbine 11 and the compressor 12 together. A turbine wheel 14 is rotatably housed inside of the exhaust turbine 11, and a compressor impeller 15 is rotatably housed inside of the compressor 12. The turbine wheel 14 and the compressor impeller 15 are integrally connected by a shaft 16, and this shaft 16 is rotatably supported by the center housing 13.

The balance correcting apparatus of this first example embodiment includes a base portion 21 that serves as a base, and a supporting portion 22 that is provided on the base portion 21 and supports a vertically lower portion of the center housing 13. An acceleration sensor 51 for detecting vibration of the supercharger 10 is mounted to the supporting portion 22. The acceleration sensor 51 is provided in a state with a detecting portion thereof contacting the center housing 13. Also, a first passage 23 and a second passage 24 that extend in the extending direction of the rotation center L of the turbine wheel 14 are provided in the base portion 21. The first passage 23 is connected to an exhaust gas introduction passage 17 for introducing exhaust gas in the exhaust turbine 11, and the second passage 24 is connected to an intake air introduction passage 18 for introducing intake air in the compressor 12. A rotation sensor 52 for detecting a rotation phase (turbo rotation phase) and a rotation speed (turbo rotation speed) of the compressor impeller 15 is provided in the second passage 24.

Also, the balance correcting apparatus of this first example embodiment includes a gas introducing portion 25 for introducing air into the exhaust turbine 11 to rotate the turbine wheel 14. The gas introducing portion 25 includes a pump 26 that pumps air, and a third passage 27 for introducing the air into the exhaust turbine 11. This third passage 27 is connected to an exhaust gas introduction passage 19 for introducing exhaust gas in the exhaust turbine 11, and the pump 26, in a state communicating the exhaust gas introduction passage 19 with a discharge portion 26A of the pump 26.

Moreover, the balance correcting apparatus of this first example embodiment includes a balance measuring device 30 that measures the balance of a rotating body formed by the turbine wheel 14, the compressor impeller 15, and the shaft 16. A detection signal from the acceleration sensor 51 and a detection signal from the rotation sensor 52 are input to the balance measuring device 30. An imbalance phase that is a portion of the rotating body that needs to be removed (a rotation phase about the rotation center L) in order correct the balance of the rotating body, and an imbalance amount that is the amount to be removed from the rotating body in order to correct the balance, are measured by a well-known method based on these detection signals.

Also, the balance correcting apparatus of this first example embodiment has a laser radiation device 40 that irradiates a laser at both end portions of the rotating body (more specifically, at a tip end portion of the turbine wheel 14 and a tip end portion of the compressor impeller 15) in the extending direction of the rotation center L of the rotating body (i.e., the left-right direction in FIG. 1). The laser radiation device 40 includes a first torch 41 that is provided inside the first passage 23 and irradiates a laser at a surface of the tip end portion of the turbine wheel 14, and a second torch 42 that is provided inside the second passage 24 and irradiates a laser at a surface of the tip end portion of the compressor impeller 15. This laser radiation device 40 removes an arc-shaped portion around the rotation center L from the tip end portion of the turbine wheel 14 by irradiating a laser from the first torch 41, and removes an arc-shaped portion around the rotation center L from the tip end portion of the compressor impeller 15 by irradiating a laser from the second torch 42.

The balance correcting apparatus of this first example embodiment includes a controller 50 that executes operation control of the pump 26, operation control of the balance measuring device 30, and operation control of the laser radiation device 40. A detection signal from the acceleration sensor 51 and a detection signal from the rotation sensor 52 are input to the controller 50.

The operation control of the pump 26 is executed in the following manner.

A control target value (target rotation speed) for the turbo rotation speed is set to match the progress of the correction of the balance of the rotating body. Also, operation of the pump 26 is controlled such that the turbo rotation speed detected by the rotation sensor 52 matches this target rotation speed.

The operation control of the balance measuring device 30 is executed in the following manner. An execution command signal is output to the balance measuring device 30 from the controller 50 at a predetermined timing to match the progression of the correction of the balance of the rotating body. The balance measuring device 30 receives the execution command signal and measures the balance. Then, the imbalance phase and the imbalance amount obtained from the results of the measurement by the balance measuring device 30 are output and input to the controller 50.

The operation control of the laser radiation device 40 is executed in the following manner. A period during which the laser is irradiated from the first torch 41 (i.e., a first target irradiating period) and a period during which the laser is irradiated from the second torch 42 (i.e., a second target irradiating period) are determined based on the most recent measurement results of the balance (i.e., the imbalance phase and the imbalance amount) by the balance measuring device 30, to match the progression of the correction of the balance of the rotating body. Then, operation of the laser radiation device 40 is controlled such that the laser is irradiated from the first torch 41 in the first target irradiating period and the laser is irradiated from the second torch 42 in the second target irradiating period, based on the turbo rotation phase detected by the rotation sensor 52.

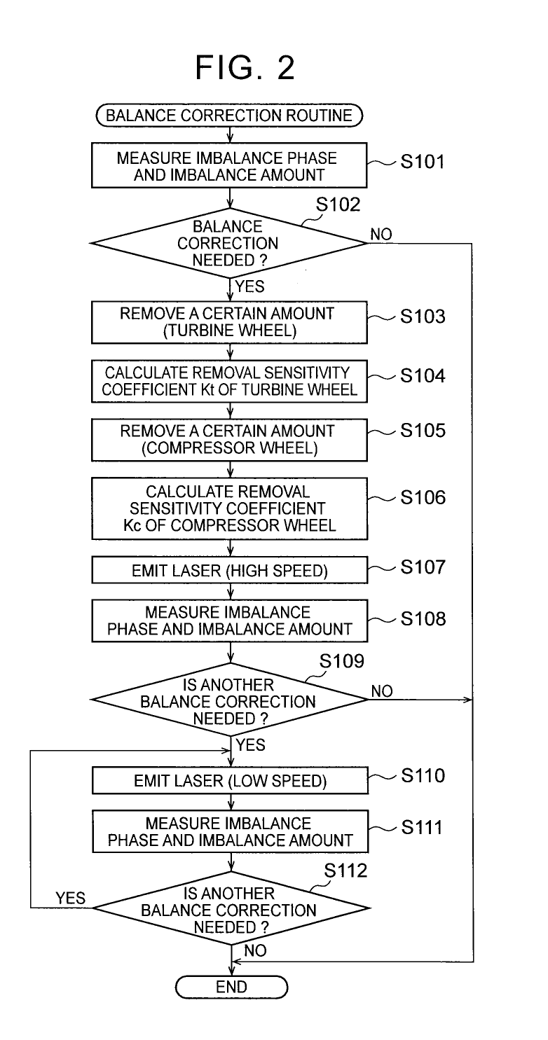

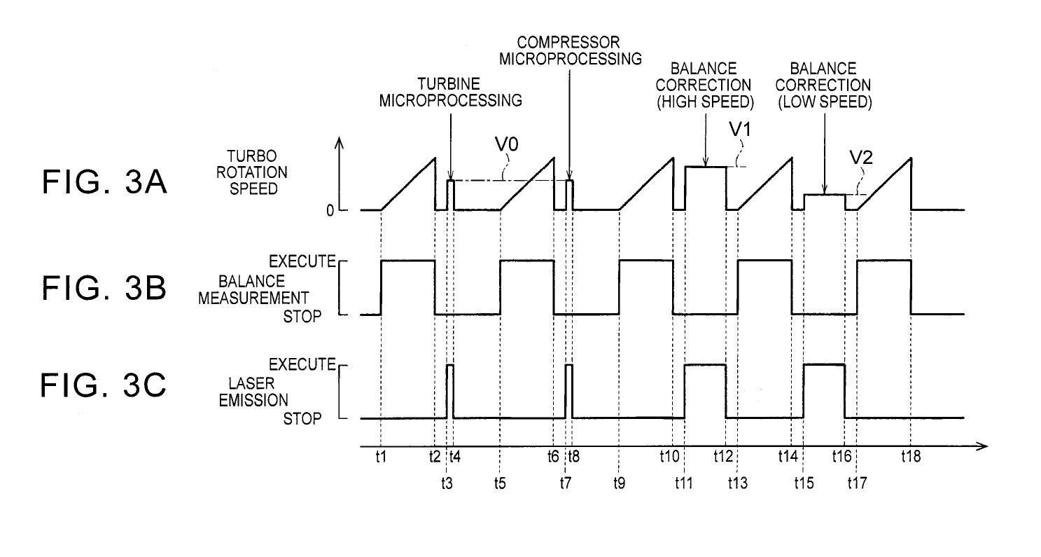

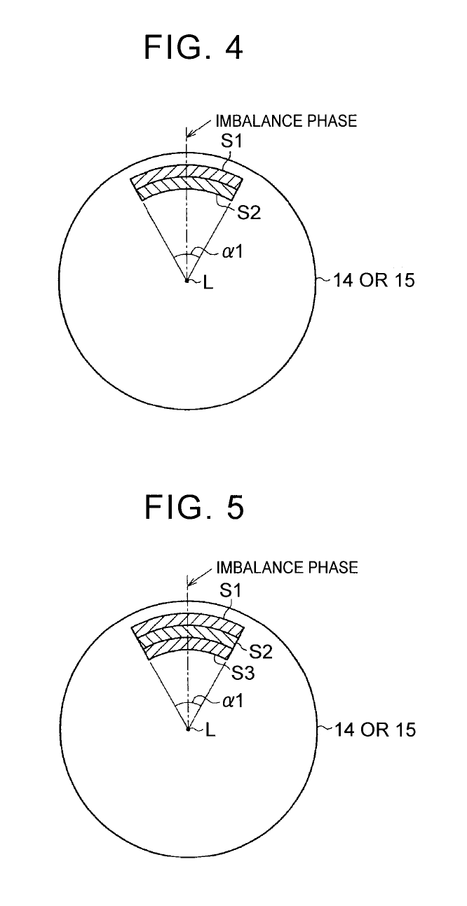

Hereinafter, the execution sequence of steps in a routine (a balance correction routine) for correcting the balance of the rotating body by the balance correcting apparatus will be described with reference to FIGS. 2 to 4. FIG. 2 is a flowchart illustrating an execution sequence of steps in the balance correction routine. The series of steps shown in the flowchart in FIG. 2 is executed by the controller 50. FIG. 3 is a timing chart illustrating the execution sequence of the steps in the balance correction routine. FIG. 4 is a simplified diagram of a laser irradiating region on the tip end portion of the turbine wheel 14 (or the compressor impeller 15).

As shown in FIG. 2, in this routine, first the imbalance phase and the imbalance amount are measured by the balance measuring device 30 (step S101). More specifically, operation control of the pump 26 is executed such that the turbo rotation speed (FIG. 3A) gradually increases as shown at time t1 to t2 in FIG. 3. Then, the balance of the rotating body is measured (FIG. 3B) by the balance measuring device 30 obtaining the relationship between vibration of the supercharger 10 and the turbo rotation phase based on the detection signal from the acceleration sensor 51 and the detection signal from the rotation sensor 52 at time t1 to t2, and calculating the imbalance phase and the imbalance amount of the rotating body based on this relationship. In this first example embodiment, step S101 corresponds to a first measuring process.

Then, it is determined whether there is a need to correct balance of the rotating body (step S102), based on the results of the measurement of the balance of the rotating body performed in step S101 in FIG. 2. If the imbalance amount calculated in step S101 is equal to or greater than a predetermined amount set in advance, then it is determined in step S102 that the balance of the rotating body needs to be corrected.

Then, if it is determined that the balance of the rotating body needs to be corrected (i.e., YES in step S102), the laser is irradiated from the first torch 41 to remove only a certain amount of the tip end portion of the turbine wheel 14 (step S103 in FIG. 2).

As shown in FIG. 4, regions S1 and S2 determined by a fixed rotation phase area α1 centered on the imbalance phase are set in advance as regions on the tip end portion of the turbine wheel 14 and the tip end portion of the compressor impeller 15 where the laser is to be irradiated when correcting the balance of the rotating body. The region S1 indicates an irradiating region when the laser is irradiated the first time to correct the balance of the rotating body (step S107 that will be described later), and the region S2 indicates an irradiating region when the laser is irradiated the second time and thereafter to correct the balance of the rotating body (step S110 that will be described later).

Then, in this first example embodiment, when correcting the balance of the rotating body, a laser with a constant emission energy per unit of time is irradiated a predetermined number of times (e.g., several times to 10 times) at the region S1 on the tip end portion of the turbine wheel 14 and the region S1 on the tip end portion of the compressor impeller 15, matching the rotation of the rotating body. In this first example embodiment, the amount of the tip end portion of the turbine wheel 14 that is removed by the laser emission and the amount of the tip end portion of the compressor impeller 15 that is removed by the laser emission are adjusted by adjusting the number of times that the laser is irradiated in this way.

In step S103, the laser is irradiated from the first torch 41 in a mode in which the laser is irradiated only once in the region S1. More specifically, the irradiating period during which the laser can be irradiated only once at the region S1 that is centered around the imbalance phase calculated in step S101 while the rotating body is rotating at a predetermined speed VO is set as the target irradiating period, based on this imbalance phase. Then, as shown at time t3 to t4 in FIG. 3, the operation control of the pump 26 is executed such that the turbo rotation speed comes to match the predetermined speed VO, and the operation control of the laser radiation device 40 is executed such that the laser is irradiated (FIG. 3C) from the first torch 41 during the target irradiating period.

Then, as shown at time t5 to t6, the imbalance amount is measured by the balance measuring device 30, and an amount of change in the imbalance amount between before and after a certain amount of the tip end portion of the turbine wheel 14 is removed is calculated based on this measurement result, and a removal sensitivity coefficient Kt is calculated based on this amount of change (step S104 in FIG. 2). As this removal sensitivity coefficient Kt, a value that becomes larger as the amount of change in the imbalance amount increases is calculated. Then, the period during which the laser is irradiated to remove the tip end portion of the turbine wheel 14 when correcting the balance of the rotating body in a later step (step S107) becomes shorter the larger the value of the removal sensitivity coefficient Kt is. By calculating this kind of removal sensitivity coefficient Kt, the laser irradiating period is able to be made shorter the larger the degree of the change in the imbalance amount of the turbine wheel 14 due to a certain amount being removed is, and the greater the possibility that the balance of the rotating body can be corrected with a small removal amount is.

Then, the laser is irradiated from the second torch 42 to remove only a certain amount (a minute amount) of the tip end portion of the compressor impeller 15 (step S105). In step S105, the laser is irradiated from the second torch 42 in a mode in which the laser is irradiated only once at the region S1 (see FIG. 4) on the tip end portion of the compressor impeller 15. More specifically, the irradiating period during which the laser is able to be irradiated in the region Si centered around the imbalance phase calculated in step S101 while the rotating body is rotating at the predetermined speed VO is set as the target irradiating period, based on this imbalance phase. Then, as shown at time t7 to t8 in FIG. 3, the operation control of the pump 26 is executed such that the turbo rotation speed comes to match the predetermined speed VO, and the operation control of the laser radiation device 40 is executed such that the laser is irradiated from the second torch 42 during the target irradiating period.

Then, as shown at time t9 and t10 in FIG. 3, the imbalance amount is measured by the balance measuring device 30, and the amount of change in the imbalance amount between before and after a certain amount of the tip end portion of the compressor impeller 15 is removed is calculated based on this measurement result, and a removal sensitivity coefficient Kc is calculated based on this amount of change (step S106 in FIG. 2). As this removal sensitivity coefficient Kc, a value that becomes larger as the amount of change in the imbalance amount increases is calculated. Then, the period during which the laser is irradiated to remove the tip end portion of the compressor impeller 15 when correcting the balance of the rotating body in a later step (step S107) becomes shorter the larger the value of the removal sensitivity coefficient Kc is. By calculating this kind of removal sensitivity coefficient Kc, the laser irradiating period is able to be made shorter the larger the degree of the change in the imbalance amount of the turbine wheel 14 due to a certain amount being removed is, and the greater the possibility that the balance of the rotating body can be corrected with a small removal amount is.

Then, the laser is irradiated at the turbine wheel 14 from the first torch 41, and the laser is irradiated at the compressor impeller 15 from the second torch 42, to correct the balance of the rotating body (step S107).

More specifically, a control target value (a first target irradiating period) for the period during which the laser is irradiated from the first torch 41 is calculated based on the imbalance phase and the imbalance amount measured in step S101 and the removal sensitivity coefficient Kt calculated in step S104. The period during which the laser is irradiated at the tip end portion of the turbine wheel 14 in step S103 is taken into account in the calculation of this first target irradiating period. Also, a control target value (a second target irradiating period) for the period during which the laser is irradiated from the second torch 42 is calculated based on the imbalance phase and the imbalance amount measured in step S101 and the removal sensitivity coefficient Kc calculated in step S106. The period during which the laser is irradiated at the tip end portion of the compressor impeller 15 in step S105 is taken into account in the calculation of this second target irradiating period.

Then, as shown at time t11 to t12 in FIG. 3, the turbo rotation speed is adjusted to a predetermined speed V1 set in advance, through the operation control of the pump 26. In this state, the laser is irradiated from the first torch 41 such that the actual irradiating period comes to match the first target irradiating period, and the laser is irradiated from the second torch 42 such that the actual irradiating period comes to match the second target irradiating period. The region where the laser is irradiated in step S107 in FIG. 2 is set to the region 51 on the outer peripheral side far from the rotation center L, from among the plurality of regions S1 and S2 shown in FIG. 4.

In this first example embodiment, a desired amount of the tip end portion of the turbine wheel 14 is removed by repeatedly irradiating the laser a predetermined number of times in the region S1 of the tip end portion of the turbine wheel 14, matching the rotation of the turbine wheel 14 as described above. Also, a desired amount of the tip end portion of the compressor impeller 15 is removed by repeatedly irradiating the laser a predetermined number of times in the region S1 of the tip end portion of the compressor impeller 15, matching the rotation of the compressor impeller 15 as described above. In this first example embodiment, values that set the irradiating periods during which the lasers are irradiated a predetermined number of times are calculated as the first target irradiating period and the second irradiating period. Also, in this first example embodiment, step S107 corresponds to a first setting process and a first correcting process, the processing portion of the rotating body to be removed in step S107 corresponds to a first processing portion, and the predetermined speed V1 corresponds to a first speed.

Then, as shown at time t13 to t14 in FIG. 3, the imbalance phase and imbalance amount is measured again by the balance measuring device 30 (step S108). In this first example embodiment, step S108 corresponds to a second measuring process.

Then, it is determined whether another balance correction of the rotating body is needed based on the measurement results of the measurements of the balance of the rotating body taken in step S108 (step S109). If it is determined that another balance correction of the rotating body is needed (i.e., YES in step S109), the laser is irradiated at the turbine wheel 14 from the first torch 41 and the laser is irradiated at the compressor impeller 15 from the second torch 42 (step S110).

More specifically, a control target value (a first target irradiating period) for the period during which the laser is irradiated from the first torch 41 is calculated based on the imbalance phase and the imbalance amount measured in step S108 and the removal sensitivity coefficient Kt calculated in step S104. Also, a control target value (a second target irradiating period) for the period during which the laser is irradiated from the second torch 42 is calculated based on the imbalance phase and the imbalance amount measured in step S108 and the removal sensitivity coefficient Kc calculated in step S106.

Then, as shown at time t15 to t16 in FIG. 3, the turbo rotation speed is adjusted to a predetermined speed V2 (where V2<V1) set in advance, through the operation control of the pump 26. In this state, the laser is irradiated from the first torch 41 such that the actual irradiating period comes to match the first target irradiating period, and the laser is irradiated from the second torch 42 such that the actual irradiating period comes to match the second target irradiating period. The region where the laser is irradiated in step S110 is set to the region S2 on the inner peripheral side near the rotation center L, from among the plurality of regions S1 and S2 shown in FIG. 4. In this first example embodiment, step S110 corresponds to a second setting process and a second correcting process, the processing portion of the rotating body that is removed in step S110 corresponds to a second processing portion, and the predetermined speed V2 corresponds to a second speed.

In this first example embodiment, a desired amount of the tip end portion of the turbine wheel 14 is removed by repeatedly irradiating the laser a predetermined number of times in the region S2 of the tip end portion of the turbine wheel 14, matching the rotation of the turbine wheel 14 as described above. Also, a desired amount of the tip end portion of the compressor impeller 15 is removed by repeatedly irradiating the laser a predetermined number of times in the region S2 of the tip end portion of the compressor impeller 15, matching the rotation of the compressor impeller 15 as described above. In this first example embodiment, values that set the irradiating periods during which the lasers are irradiated a predetermined number of times are calculated as the first target irradiating period and the second irradiating period.

Then, as shown at time t17 to t18 in FIG. 3, the imbalance phase and imbalance amount is measured again by the balance measuring device 30 (step S111). Then, it is determined whether another balance correction of the rotating body is needed based on the measurement results of the measurements of the balance of the rotating body taken in step S111 (step S112). If it is determined that another balance correction of the rotating body is needed (i.e., YES in step S112), the processes in steps S110 to S112 are repeatedly executed until it is determined that another balance correction of the rotating body is not needed in step S112. In this case, when calculating the first target irradiating period and the second target irradiating period in step S110, the imbalance phase and the imbalance amount measured in step S111 are used as the calculation parameters.

On the other hand, if it is determined that another balance correction of the rotating body is not needed (i.e., NO in step S112), the routine ends. FIG. 3 is a view of an example in which it is determined that another balance correction of the rotating body is not needed in the first step S112.

If it is determined in step S102 that a balance correction of the rotating body is not needed (i.e., NO in step S102) or it is determined in step 5109 that another balance correction of the rotating body is not needed (i.e., NO in step S109), the routine ends.

Hereinafter, the operation from correcting the balance of the rotating body through the balance correction routine will be described.

In this first example embodiment, if, as a result of measuring the balance of the rotating body by the balance measuring device 30, it is determined that another balance correction needed, the laser is irradiated at the rotating body while the rotating body is rotating at the predetermined speed V1. As a result, the tip end portion of the turbine wheel 14 and the tip end portion of the compressor impeller 15 are removed, such that the balance of the rotating body is corrected.

Then, after correcting the balance of the rotating body in this way, the balance is measured again, and if the measurement results indicate that the balance correction is insufficient, the laser is irradiated at the rotating body while the rotating body is rotated at a speed (the predetermined speed V2) lower than the rotation speed (the predetermined speed V1) of the rotating body when the balance was most recently corrected. As a result, the tip end portion of the turbine wheel 14 and the tip end portion of the compressor impeller 15 are removed, such that the balance of the rotating body is corrected again.

Here, when removing the processing portion of the rotating body by irradiating the laser, vibration of the rotating body, and thus misalignment of the area where the laser is irradiated, are able to be inhibited by reducing the rotation speed of the rotating body, so the balance correction accuracy of the rotating body increases.

In this first example embodiment, if, as a result of removing the first processing portion of the rotating body while the rotating body is rotated at a relatively high speed (the predetermined speed V1), the balance correction of the rotating body is insufficient, the second processing portion of the rotating body may be removed while the rotating body is rotated at a low speed (the predetermined speed V2), i.e., while the rotating body is rotated at a speed at which high correction accuracy can be expected. As a result, another accurate correction of the balance of the rotating body by removing the second processing portion is made, which makes it possible to inhibit the balance measurement by the balance measuring device 30 and another balance correction based on those measurement results from being repeated. Consequently, the balance correction of the rotating body is able to be efficiently performed in a short period of time.

In this first example embodiment, an arc-shaped portion around the rotation center L is removed from the tip end portion of the turbine wheel 14 by irradiating a laser at the tip end portion of the turbine wheel 14, and an arc-shaped portion around the rotation center L is removed from the tip end portion of the compressor impeller 15 by irradiating a laser at the tip end portion of the compressor impeller 15. Also, the first processing portion (region S1 in FIG. 4) that is the portion that is removed by irradiating the laser in the first balance correction is positioned to the inner peripheral side nearer the rotation center L than the second processing portion (the region S2) that is the portion that is removed by irradiating the laser in another balance correction.

Here, when an arc-shaped portion around the rotation center L is removed from the tip end portion of the turbine wheel 14 and the tip end portion of the compressor impeller 15, the length around the rotation center L of the portion where the processing portion that is the portion that is removed can be set becomes longer, and thus the area where the processing portion can be set becomes wider, the farther the processing portion is to the outer peripheral side away from the rotation center L. According to this first example embodiment, when the first balance correction is performed, the processing portion (i.e., the first processing portion) is able to be set to a portion on the outer peripheral side, i.e., a portion in which the area where the processing portion can be set is large, of the tip end portion of the turbine wheel 14 and the tip end portion of the compressor impeller 15, so the first processing portion can be set with a high degree of freedom.

Also, if a hole formed in the turbine wheel 14 or the compressor impeller 15 with the removal of the processing portion by the laser emission becomes too deep, the material melted by the laser emission may be unable to be excreted outside of the hole and scattered. Also, if the first processing portion in the first balance correction and the second processing portion in the follow-up balance correction are set to the same region, the region that was processed once in the first balance correction will be processed again in the follow-up balance correction, so the hole formed in the turbine wheel 14 or the compressor impeller 15 tends to become deep. Therefore, the removal amount that can be removed from the rotating body by the emission of the laser in this case may be less. On this point, in this first example embodiment, if there is a need for another balance correction, the second processing portion is set to the region closer to the inner peripheral side of the tip end portion of the turbine wheel 14 (or the tip end portion of the compressor impeller 15) than the first processing portion (region S1) in the first balance correction, i.e., to a region (region S2) that differs from the first processing portion in the first balance correction. Therefore, a hole formed with the removal of the processing portion of the rotating body is able to be inhibited from becoming deeper, and the removal amount that can be removed in both the first balance correction and the follow-up balance correction is able to be increased.

In this way, according to this first example embodiment, the balance correction of the rotating body is able to be performed with a high degree of freedom. As described above, with this first example embodiment, the effects described below are able to be obtained.

(1) If, as a result of removing the first processing portion of the rotating body while the rotating body is rotated at the relatively high predetermined speed V1, the balance correction of the rotating body is insufficient, the second processing portion of the rotating body may be removed while the rotating body is rotated at the low predetermined speed V2, i.e., while the rotating body is rotated at a speed at which high correction accuracy can be expected. As a result, it possible to inhibit the balance measurement by the balance measuring device 30 and another balance correction based on those measurement results from being repeated, so the balance correction of the rotating body is able to be efficiently performed in a short period of time.

(2) According to this first example embodiment, when the balance correction is performed, the first processing portion is able to be set to a portion on the outer peripheral side, i.e., a portion in which the area where the processing portion can be set is large, of the tip end portion of the turbine wheel 14 and the tip end portion of the compressor impeller 15, so the first processing portion can be set with a high degree of freedom. Also, if there is a need for another balance correction, the second processing portion is set to the region closer to the inner peripheral side of the tip end portion of the turbine wheel 14 (or the tip end portion of the compressor impeller 15) than the first processing portion (region S1) in the first balance correction, i.e., to a region (region S2) that differs from the first processing portion in the first balance correction. Therefore, the removal amount that can be removed in both the first balance correction and the follow-up balance correction is able to be increased. In this way, with this first example embodiment, the balance correction of the rotating body can be executed with a high degree of freedom.

Next, a second example embodiment of the rotating body balance correcting apparatus and balance correcting method will be described focusing on the difference from the first example embodiment.

The second example embodiment differs from the first example embodiment on the following points. In the first example embodiment, when correcting the balance of the rotating body again, only one second processing portion (see region S2 in FIG. 4) that is the portion that is removed by laser emission is provided. In contrast, in this second example embodiment, a plurality of processing portions (regions S2 and S3) lined up from a position on the outer peripheral side away from the rotation center L towards a position to the inner peripheral side near the rotation center L are set as the second processing portion of the rotating body (the tip end portion of the turbine wheel 14 and the tip end portion of the compressor impeller 15) when the balance of the rotating body is corrected again, as shown in FIG. 5. Also, when the balance of the rotating body is corrected again, the turbo rotation speed is adjusted to be a higher speed when the laser is irradiated at a processing portion that is closer to the inner peripheral side near the rotation center L.

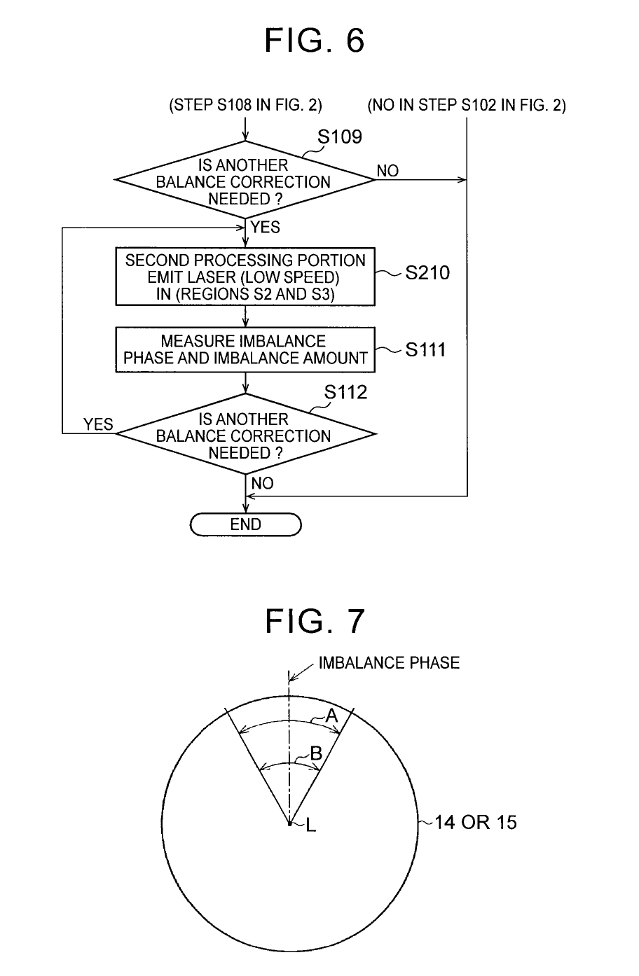

Hereinafter, a routine (balance correction routine) to correct the balance in the second example embodiment will be described. FIG. 6 is a flowchart illustrating an execution sequence of steps in this balance correction routine. The series of steps shown in the flowchart in FIG. 6 is executed by the controller 50. The balance correction routine of this second example embodiment is similar to the balance correction routine (see FIG. 2) of the first example embodiment, so like steps will be denoted by like reference characters, and detailed descriptions of those steps will be omitted.

As shown in FIG. 6, in the balance correction routine, if it is determined that another balance correction of the rotating body is needed (i.e., YES in step S109), the laser is irradiated at the turbine wheel 14 from the first torch, and the laser is irradiated at the compressor impeller 15 from the second torch (step S210).

More specifically, a control target value (a first target irradiating period) for the period during which the laser is irradiated from the first torch 41 is calculated based on the imbalance phase and the imbalance amount measured in step S108 (FIG. 2) and the removal sensitivity coefficient Kt calculated in step S104. Also, a control target value (a second target irradiating period) for the period during which the laser is irradiated from the second torch 42 is calculated based on the imbalance phase and the imbalance amount measured in step S108 and the removal sensitivity coefficient Kc calculated in step S106.

In this second example embodiment, a maximum number of times (10 times in this second example embodiment) is set for the number of times that the laser is irradiated at the processing portion (region S2) on the outer peripheral side of the second processing portion. Then, if the balance of the rotating body is unable to be sufficiently corrected even when the laser is repeatedly irradiated the maximum number of times at the processing portion on the outer peripheral side, e.g., when the imbalance amount calculated in step S108 is large, the laser is additionally irradiated at the processing portion (region S3) on the inner peripheral side. In step S210, a period during which the laser is irradiated at the processing portion on the outer peripheral side and a period during which the laser is irradiated at the processing portion on the inner peripheral side are calculated as a first target irradiating period and a second target irradiating period.

Also, in step S210, the turbo rotation speed is adjusted to a predetermined speed V3 (where V3<V1) that is preset, through the operation control of the pump 26. In this state, the laser is irradiated at the processing portion (region S2) on the outer peripheral side from the first torch 41 such that the actual irradiating period comes to match the first target irradiating period, and the laser is irradiated at the processing portion (region S2) on the outer peripheral side from the second torch 42 such that the actual irradiating period comes to match the second target irradiating period.

When the laser is irradiated at the processing portion (region S3) on the inner peripheral side, the turbo rotation speed is adjusted to a predetermined speed V4 (where V3<V4<V1) set in advance, through the operation control of the pump 26, after the laser has finished being irradiated at the processing portion (region S2) on the outer peripheral side. Then, in this state, the laser is irradiated at the processing portion (region S3) on the inner peripheral side from the first torch 41 such that the actual irradiating period comes to match the first target irradiating period, and the laser is irradiated at the processing portion (region S3) on the inner peripheral side from the second torch 42 such that the actual irradiating period comes to match the second target irradiating period. In this second example embodiment, speeds at which the amount of energy per unit area that is applied to the rotating body by the laser emission will be the same at the processing portion on the outer peripheral side and the processing portion on the inner peripheral side are set as the predetermined speeds V3 and V4 based on the results of various tests and simulations.

Then, the imbalance phase and the imbalance amount are measured again by the balance measuring device 30 (step S111). (Operation) Hereinafter, the operation by correcting the balance of the rotating body through the balance correction routine will be described.

As shown in FIG. 7, when a laser with a constant emission energy per unit of time is irradiated for a certain period of time at the rotating body while the rotating body is rotated at a predetermined speed, the length (the length indicated by arrows A and B in the drawing) in the circumferential direction of the portion where the laser is irradiated becomes shorter the closer the irradiated portion is to the inner peripheral side near the rotation center L of the rotating body. Therefore, in this case, it can be said that the amount of energy per unit area that is applied to the rotating body by irradiating the laser is greater the closer the irradiated portion is to the inner peripheral side near the rotation center L of the rotating body. Therefore, if the rotation speed of the rotating body is constant when a laser is irradiated separately at the processing portion on the outer peripheral side away from the rotation center L of the rotating body and the processing portion on the inner peripheral side near the rotation center L of the rotating body, there may be variation in the amount of energy per unit area that is applied to the rotating body between these processing portions, so there may be variation in the removal of the processing portions.

In this second example embodiment, the rotation speed of the rotating body is a higher speed when the target of laser emission is the processing portion (region S3) on the inner peripheral side than when the target of laser emission is the processing portion (region S2) on the outer peripheral side. Therefore, variation in the length in the circumferential direction of the irradiated portion when a laser in which the irradiated energy per unit time is a constant energy is irradiated for a certain period of time is able to be reduced between processing portions, so variation in the amount of energy per unit area that is applied to the rotating body by emission of the laser is able to be reduced between processing portions. As a result, the setting for the removal of each processing portion of the second processing portion is able to be performed easily, so the balance is able to be easily corrected.

As described above, with this second example embodiment, the effect described in (3) below is able to be obtained in addition to the effects described in (1) and (2) above.

(3) When correcting the balance of the rotating body again, a plurality of processing portions (regions S2 and S3) lined up from a position on the outer peripheral side away from the rotation center L towards a position to the inner peripheral side near the rotation center L are set as the processing portion that is the portion that is removed by emission of the laser when correcting the balance of the rotating body again. Also, when correcting the balance of the rotating body again, the turbo rotation speed is adjusted to be a higher speed when the laser is irradiated at a processing portion that is closer to the inner peripheral side near the rotation center L. As a result, the setting for the removal of the processing portions in the second processing portion is able to be performed easily, so the balance is able to be easily corrected.

The example embodiments described above may also be modified as described below. Hence, modified examples of the example embodiments described above will be described next.

First, a first modified example will be described. The period during which the laser is irradiated in the process to remove a certain amount of the tip end portion of the turbine wheel 14 (step S103) and the process to remove a certain amount of the tip end portion of the compressor impeller 15 (step S105) in the balance correction routine may be modified appropriately. That is, an appropriate period may be set as long as it is a period in which the laser is able to be irradiated in a fixed rotation phase area centered around the imbalance phase.

Next, a second modified example will be described. In the balance correction routine, the region where the laser is irradiated may be modified appropriately in the process to remove a certain amount of the tip end portion of the turbine wheel 14 (step S103) and the process to remove a certain amount of the tip end portion of the compressor impeller 15 (step S105). For example, the laser may be irradiated in the region S2, or the laser may be irradiated in a region other than the regions S1 and S2.

Next, a third modified example will be described. The process to remove a certain amount of the tip end portion of the turbine wheel 14 (step S103) and the process to calculate the removal sensitivity coefficient Kt of the turbine wheel 14 (step S104) may be omitted. In this case, in step S107, the first target irradiating period may be calculated based on the imbalance phase and the imbalance amount calculated in step S103, without using the removal sensitivity coefficient Kt to calculate the first target irradiating period.

Also, the process to remove a certain amount of the tip end portion of the compressor impeller 15 (step S105) and the process to calculate the removal sensitivity coefficient Kc of the compressor impeller 15 (step S106) may be omitted. In this case, in step S107, the second target irradiating period may be calculated based on the imbalance phase and the imbalance amount calculated in step S103, without using the removal sensitivity coefficient Kc to calculate the second target irradiating period.

Next, a fourth modified example will be described. A laser may be irradiated in the same region on the tip end portion of the turbine wheel 14 and the tip end portion of the compressor impeller 15 when removing the first processing portion of the rotating body in step S107 of the balance correction routine and when removing the second processing portion of the rotating body in step S110 of the balance correction routine.

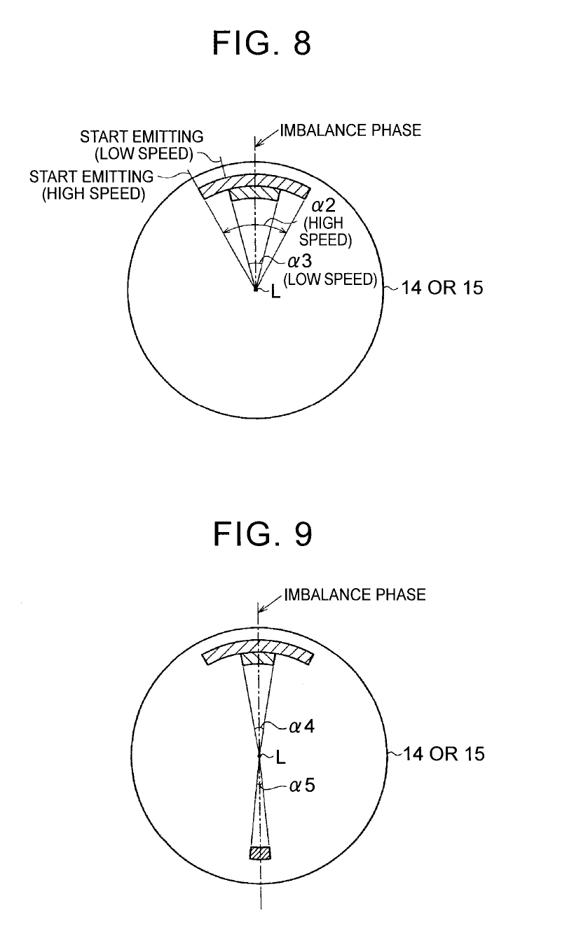

Next, a fifth modified example will be described. The adjustment of the removal amount of the portion to be removed by irradiating the laser is not limited to being performed through setting the number of times that the laser is irradiated in the regions S1 and S2, but may also be performed through adjustment of the rotation phase area where the laser is irradiated. In this case, as shown in FIG. 8, the timing at which the laser starts to be irradiated may be different in a first balance correction in which the laser is irradiated while the rotating body is rotated at a relatively high predetermined speed V1 than it is in a follow-up balance correction in which the laser is irradiated while the rotating body is rotated at a low predetermined speed V2. As a result, the period during which the laser is irradiated in the first balance correction and in the follow-up balance correction can be made a period in which the laser is irradiated in fixed rotation phase areas (the phase areas indicated by α2 and α3 in FIG. 8) that are centered around the imbalance phase. Also, the adjustment of the removal amount of the portion to be removed by emission of the laser may be performed by adjusting the emission energy per unit time of the laser or the like.

Next, a sixth modified example will be described. In step S107 in the balance correction routine, a plurality of processing portions that are lined up from a position on the outer peripheral side away from the rotation center L toward a position on the inner peripheral portion near the rotation center L may be set as the first processing portion that is the portion that is removed by emission of the laser. As a result, compared to when only one processing portion is set, the region where the processing portion can be set is able to be wider, so the maximum value of the removal amount that can be removed by emission of the laser is able to be greater. Therefore, the degree of freedom in setting the balance correction routine is able to be increased.

Also, in this case, the turbo rotation speed may be adjusted to a higher speed when the laser is irradiated to a processing portion that is closer to the inner peripheral side near the rotation center L. Therefore, variation in the length in the circumferential direction of the irradiated portion when a laser in which the irradiated energy per unit time is a constant energy is irradiated for a certain period of time is able to be reduced between processing portions, so variation in the amount of energy per unit area that is applied to the rotating body by emission of the laser is able to be reduced between processing portions. As a result, the setting for the removal of each processing portion of the second processing portion is able to be performed easily, so the balance is able to be easily corrected.

Next, a seventh modified example will be described. As shown in FIG. 9, when removing the second processing portion of the rotating body in step S110 (see FIG. 2), the laser may be irradiated in a rotation phase area (the area indicated by α5 in FIG. 9) that is centered around a phase that differs by 180° from the imbalance phase may be irradiated in addition to irradiating the laser in a rotation phase area (the area indicated by α4 in FIG. 9) that is centered around the imbalance phase. Here, variation tends to occur in the emission energy when starting and stopping emission of the laser. Therefore, when the imbalance amount calculated in step S108 or step S111 in the balance correction routine is small and the removal amount by laser emission is small, the balance correction may be affected by the variation in the irradiated energy and thus may not be able to be accurately performed. Regarding this, by removing the processing portions by irradiating the laser at phases that differ by 180° as in the structure described above, the balance of the rotating body is able to be corrected by the difference in the removal amounts of the processing portions, so the laser irradiating period at each processing portion is able to be lengthened. As a result, the effect of the variation in the irradiated energy on the processing portions is able to be reduced, so even if the imbalance amount is small, the balance correction of the rotating body is able to be accurately performed.

The balance correcting apparatus and balance correcting method of the example embodiments described above may also be applied to a variable capacity supercharger such as a supercharger having a variable nozzle mechanism. Also, the balance correcting apparatus and balance correcting method may also be applied to a supercharger with a built-in electric motor for rotatably driving the rotating body. In this case, the gas introducing portion 25 may be omitted, and the rotating body may be rotated by the electric motor when correcting the balance of the rotating body.

The balance correcting apparatus and balance correcting method may also be applied to an apparatus that removes a processing portion of the rotating body by irradiating the laser at only one of the tip end portion of the turbine wheel 14 and the tip end portion of the compressor impeller 15, when correcting the balance of the rotating body.

The portion where the laser is irradiated when correcting the balance of the rotating body is not limited to the tip end portion of the turbine wheel 14 and the tip end portion of the compressor impeller 15, and may also be an outer peripheral portion in the rotational direction of the turbine wheel 14 and the compressor impeller 15.

What is claimed is:

1. A rotating body balance correcting apparatus comprising:
a measuring device configured to measure a balance of a rotating body;
a laser radiation device configured to irradiate a laser at a surface of the rotating body; and
a controller configured to:
(i) control operation of the measuring device and the laser radiation device;
(ii) correct the balance of the rotating body by irradiating the laser with the laser radiation device at a first processing portion of the rotating body set based on a result of measuring the balance by the measuring device while the rotating body is rotated, and removing the first processing portion;
(iii) measure the balance of the rotating body again after removing the first processing portion; and
(iv) when the result of measuring the balance again is a result in which the correction of the balance is insufficient, rotate the rotating body at a speed different from a rotation speed of the rotating body when the first processing portion is removed, and irradiate the laser with the laser radiation device at a second processing portion of the rotating body set based on a result of measuring the balance again, and remove the second processing portion.

2. The rotating body balance correcting apparatus according to claim 1, wherein
the laser radiation device is configured to irradiate the laser at an end portion of the rotating body in an extending direction of a rotation center of the rotating body, and remove an arc-shaped portion around the rotation center from the end portion; and
the controller is configured to position the second processing portion closer to an inner peripheral side near the rotation center than the first processing portion.

3. The rotating body balance correcting apparatus according to claim 2, wherein
the second processing portion includes a plurality of processing portions lined up from a position on an outer peripheral side away from the rotation center toward a position on an inner peripheral side near the rotation center; and
the controller is configured to:
(i) irradiate a laser in which an irradiated energy per unit time is constant, at the plurality of processing portions; and
(ii) increase a rotation speed of the rotating body when a target at which the laser is irradiated is a processing portion that is closer to the inner peripheral side, from among the plurality of processing portions.

4. The rotating body balance correcting apparatus according to claim 1, wherein
the controller is configured to:
make a rotation speed of the rotating body when the laser is irradiated at the second processing portion lower than a rotation speed of the rotating body when the laser is irradiated at the first processing portion.

5. The rotating body balance correcting apparatus according to claim 1, wherein
the controller is configured to:
make a rotation phase area where the laser is irradiated at the second processing portion different from a rotation phase area where the laser is irradiated at the first processing portion.

6. The rotating body balance correcting apparatus according to claim 1, wherein
the controller is configured to:
make a rotation phase area where the laser is irradiated at the second processing portion different from a rotation phase area where the laser is irradiated at the first processing portion by 180°.

7. A rotating body balance correcting method comprising:
a first measuring process of measuring a balance of a rotating body;
a first setting process of setting a first processing portion of the rotating body based on a result of measuring the balance in the first measuring process;
a first correcting process of correcting the balance of the rotating body by irradiating a laser at the first processing portion while the rotating body is being rotated at a first speed and removing the first processing portion;
a second measuring process of measuring the balance of the rotating body after the first correcting process;
a second setting process of setting a second processing portion of the rotating body based on a result of measuring the balance in the second measuring process, when a measurement result of the balance in the second measuring process is a result indicating that the correction of the balance of the rotating body in the first correcting process is insufficient; and
a second correcting process of correcting the balance of the rotating body again by irradiating the laser at the second processing portion when the rotating body is rotated at a second speed that differs from the first speed and removing the second processing portion.

8. The rotating body balance correcting method according to claim 7, wherein
removal of the first processing portion in the first correcting process and removal of the second processing portion in the second correcting process are executed by irradiating the laser at an end portion of the rotating body in an extending direction of a rotation center of the rotating body, and removing an arc-shaped portion around the rotation center from the end portion; and
in the second correcting process, the second processing portion is positioned closer to an inner peripheral side near the rotation center than the first processing portion.

9. The rotating body balance correcting method according to claim 8, wherein
in the second setting process, a plurality of processing portions that are lined up from a position on an outer peripheral side away from the rotation center toward a position on an inner peripheral side near the rotation center are set as the second processing portion, and
in the second correcting process, a laser in which an irradiatedd energy per unit time is constant, is irradiated at the plurality of processing portions, and a rotation speed of the rotating body is increased when a target at which the laser is irradiated is a processing portion that is closer to the inner peripheral side, from among the plurality of processing portions.

10. The rotating body balance correcting method according to claim 7, wherein
in the second correcting process, a rotation speed of the rotating body when the laser is irradiated at the second processing portion is lower than a rotation speed of the rotating body when the laser is irradiated at the first processing portion.

11. The rotating body balance correcting method according to claim 7, wherein
in the second correcting process, a rotation phase area where the laser is irradiated at the second processing portion is made to differ from a rotation phase area where the laser is irradiated at the first processing portion.

12. The rotating body balance correcting method according to claim 7, wherein
in the second correcting process, a rotation phase area where the laser is irradiated at the second processing portion is made to differ from a rotation phase area where the laser is irradiated at the first processing portion by 180°.
